(19) United States
(12) Patent Application Publication
(10) Pub. No.: US 2012/0120529 A1
(43) Pub. Date: May 17, 2012

(54) VOICE-COIL MOTOR WITH FLUX GUIDE CONFIGURED TO REDUCE HEAD VIBRATIONS IN A DISK DRIVE

(76) Inventors: Takeshi Ozaki, Ibaraki (JP); Toshihiko Shimizu, Ibaraki (JP)

(21) Appl. No.: 12/944,689

(22) Filed: Nov. 11, 2010

(51) Int. Cl. G11B 5/40

(52) U.S. Cl. 360/264.7; G9B/5.143

(57) ABSTRACT

A voice-coil motor (VCM) with a flux guide configured to reduce vibrations of a head when accessing data in a disk drive. The VCM includes at least one VCM magnet, a voice coil, and at least one flux guide. The voice coil is disposed in proximity to a magnetic pole of the VCM magnet. The flux guide is coupled to the voice coil; and, the flux guide is configured to reduce vibrations of the head when accessing data in the disk drive.

### TECHNICAL FIELD

Embodiments of the present invention relate generally to the field of voice-coil motors (VCMs) of disk drives.

### BACKGROUND

Disk drives are known in the art that use various kinds of disks, such as: optical disks, magneto-optical disks, flexible magnetic-recording disks, and similar disk data-storage devices. In particular, hard-disk drives (HDDs) have been widely used as indispensable data-storage devices for current computer systems. Moreover, HDDs have found widespread application to motion picture recording and reproducing apparatuses, car navigation systems, cellular phones, and similar devices, in addition to the computers, because of their outstanding information-storage characteristics.

In standard HDDs, a rotary actuator having a magnetic-recording head mounted at one end is driven in rotation about a pivot shaft of the rotary actuator, and, by this means, the magnetic-recording head can be positioned at any radial position over a magnetic-recording disk so that writing data to, and reading data from, the magnetic-recording disk can be performed. A voice coil is mounted at the other end of the rotary actuator, and the drive force for rotating the rotary actuator is produced by means of a voice-coil motor (VCM), which includes a VCM magnet that is secured to the disk enclosure (DE) of the HDD. The VCM has a structure in which the voice coil is vertically disposed between yokes made of a soft magnetic material in order to form a magnet for generating magnetic flux and a magnetic circuit.

In a first example known in the art, a VCM may include a flux guide that is disposed between the furthest end of the voice coil from the pivot shaft on substantially the same plane as the VCM magnet, which is disposed on the yokes, and the furthest part of the VCM magnet from the pivot shaft. In this design, the action of the magnetic flux generated by the VCM magnet is suppressed in the direction parallel to the plane of the voice coil at the outer peripheral portion of the voice coil, which is distant from the pivot shaft, within the portion of the voice coil which is substantially parallel to the direction of rotation of the rotary actuator about the pivot shaft.

In a second example known in the art, a VCM may include an iron piece that is disposed on a side surface of a portion of the voice coil, which is disposed between an upper yoke and a lower yoke, and is substantially perpendicular to the direction of rotation of a rotary actuator about the pivot shaft. In this design, a second magnet is disposed on the side surface of the yoke opposite the iron piece, such that impacts and vibration are reduced during loading and unloading of the magnetic-recording head unto the magnetic-recording disk in a HDD with a load/unload ramp.

These designs suggest that engineers and scientists engaged in HDD manufacturing and development have an on-going interest in the design of HDDs that control the motion of the rotary actuator that bears the magnetic-recording head in accessing data written to, and read back from, the magnetic-recording disk to meet the rising demands of the marketplace for increased data-storage capacity, performance, and reliability of HDDs.

### SUMMARY

Embodiments of the present invention include a voice-coil motor (VCM) with a flux guide configured to reduce vibrations of a head when accessing data in a disk drive. The VCM includes at least one VCM magnet, a voice coil, and at least one flux guide. The voice coil is disposed in proximity to a magnetic pole of the VCM magnet. The flux guide is coupled to the voice coil; and, the flux guide is configured to reduce vibrations of the head when accessing data in the disk drive.

### DESCRIPTION OF THE DRAWINGS

The accompanying drawings, which are incorporated in and form a part of this specification, illustrate embodiments of the invention and, together with the description, serve to explain the embodiments of the invention:

FIG. 1 is an oblique view showing an example embodiment of the hard-disk drive (HDD), in accordance with embodiments of the present invention.

FIG. 2 is an exploded oblique view of the voice-coil motor (VCM) including the voice coil, VCM magnet, and flux guide, in accordance with a first example embodiment of the present invention.

FIG. 3 is a top transparent view of the VCM including the voice coil, VCM magnet, and flux guide, in accordance with the first example embodiment of the present invention.

FIG. 4 is a cross-sectional elevation view of the VCM including the voice coil, VCM magnet, and flux guide through a cross section along line A-A′ of FIG. 3, in accordance with the first example embodiment of the present invention.

FIG. 5 is a cross-sectional elevation view of the VCM including the voice coil and VCM magnet through a cross section along contour B-B′ in FIG. 3, in accordance with the first example embodiment of the present invention.

FIG. 6 is a perspective view of the voice coil illustrating the principle of operation of the VCM by which the voice coil is moved by a drive force generated by interaction of a current flowing through the voice coil with a magnetic field emanating from the VCM magnet, in accordance with the first example embodiment of the present invention.

FIG. 7 is a cross-sectional elevation view of the VCM including the voice coil, and VCM magnet illustrating the results of a magnetic field analysis for the outer peripheral portion of the voice coil in the case where the voice coil does not utilize a flux guide.

FIG. 8 is a cross-sectional elevation view of the VCM including the voice coil, VCM magnet, and flux guide illustrating the results of a magnetic field analysis for the outer peripheral portion of the voice coil in the case where the voice coil does utilize a flux guide, in accordance with the first example embodiment of the present invention.

FIG. 9 is a bar chart based on the results of magnetic field analysis yielding the out-of-plane excitation force on the outer peripheral portion of the voice coil comparing the case where the voice coil does not utilize a flux guide (prior art) with the case where the voice coil does utilize a flux guide that is in accordance with the first example embodiment of the present invention.

FIG. 10 is a cross-sectional elevation view of the VCM including the voice coil, a VCM magnet, and two flux guides, in accordance with a second example embodiment of the present invention.

FIG. 11 is a cross-sectional elevation view of the VCM including the voice coil, two VCM magnets, and a flux guide, in accordance with a third example embodiment of the present invention.

FIG. 12 is a cross-sectional elevation view of the VCM including the voice coil, VCM magnet, and flux guide, in accordance with a fourth example embodiment of the present invention.

FIG. 13 is a cross-sectional elevation view of the VCM including the voice coil, VCM magnet, and a flux guide including a first portion disposed on an upper side of an outer peripheral portion of the voice coil and a second portion disposed on a lower side of the outer peripheral portion of the voice coil, in accordance with a fifth example embodiment of the present invention.

FIG. 14 is a cross-sectional elevation view of the VCM including the voice coil, VCM magnet, and flux guide, in accordance with a sixth example embodiment of the present invention.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be noted that embodiments of the present invention may be practiced without these specific details. In other instances, well known methods, procedures, and components have not been described in detail as not to unnecessarily obscure embodiments of the present invention. Throughout the drawings, like components are denoted by like reference numerals, and repetitive descriptions are omitted for clarity of explanation if not necessary.

Physical Description of Embodiments of the Present Invention for a Voice-Coil Motor with Flux Guide Configured to Reduce Head Vibrations in a Disk Drive

With relevance to embodiments of the present invention, the voice-coil motor (VCM), ideally, generates only a force that causes rotation of the rotary actuator. However, a force parallel to the pivot shaft may be generated because of the structure, shape, and assembly variations of the VCM. The force parallel to the pivot shaft acts in a direction perpendicular to the movement plane of the voice coil for accessing data in the disk drive, for example, a hard-disk drive (HDD); and, therefore, this force parallel to the pivot shaft may be referred to by the term of art, “out-of-plane excitation force”. As used herein, the term of art, “out-of-plane,” refers to the direction about perpendicular to the plane in which the voice coil lies. The out-of-plane excitation force is produced when there is a component in the magnetic field emanating from the VCM magnet that is parallel to the plane in which the voice coil lies. The out-of-plane excitation force acts on the voice coil, and is especially large in HDDs in which only one VCM magnet is used in order to reduce cost. The out-of-plane excitation force has the greatest effect at the outer peripheral portion of the voice coil, which is distal from the pivot shaft that constitutes the rotational center of the rotary actuator.

With further relevance to embodiments of the present invention, when the out-of-plane excitation force is large, the excitation force in the direction parallel to the pivot shaft acts on the rotary actuator; and, therefore, a vibration mode is produced in which the voice coil vibrates up and down. The up-and-down vibration of the voice coil creates an impediment to the accurate positioning of the magnetic-recording head on a specific recording track of the magnetic-recording disk. The positioning accuracy of the magnetic-recording head is impaired, which presents an obstacle to increasing the data-storage capacity of the HDD.

As described above, the first example known in the art relates to a structure in which a flux guide is disposed between the furthest end of the voice coil from the pivot shaft and the furthest end of the VCM magnet from the pivot shaft on substantially the same plane as the VCM magnet. Although the first example known in the art reduces the out-of-plane excitation force; the first example known in the art is different from embodiments of the present invention.

Similarly, as described above, the second example known in the art relates to a structure in which an iron piece is disposed only on a side surface of a portion of the voice coil which is substantially perpendicular to the direction of rotation of a rotary actuator about a pivot shaft in order to reduce impacts and vibration during loading and unloading of the magnetic-recording head from the magnetic-recording disk. The second example known in the art does not address the out-of-plane excitation force that is produced inside the above-described VCM; rather, the iron piece disposed on the side surface of the voice coil constitutes a flux guide, and a component in the magnetic field that is parallel to the plane in which the voice coil lies, which acts on the portion of the voice coil lying at a position substantially perpendicular to the direction of rotation about the pivot shaft. Consequently, the second example known in the art leads to an increase in the out-of-plane excitation force, in contrast with embodiments of the present invention.

Embodiments of the present invention provide a large, data-storage capacity HDD in which the out-of-plane excitation force acting on the voice coil is reduced, and the positioning accuracy of the magnetic-recording head on a specific recording track is increased by suppressing vibration of the magnetic-recording head.

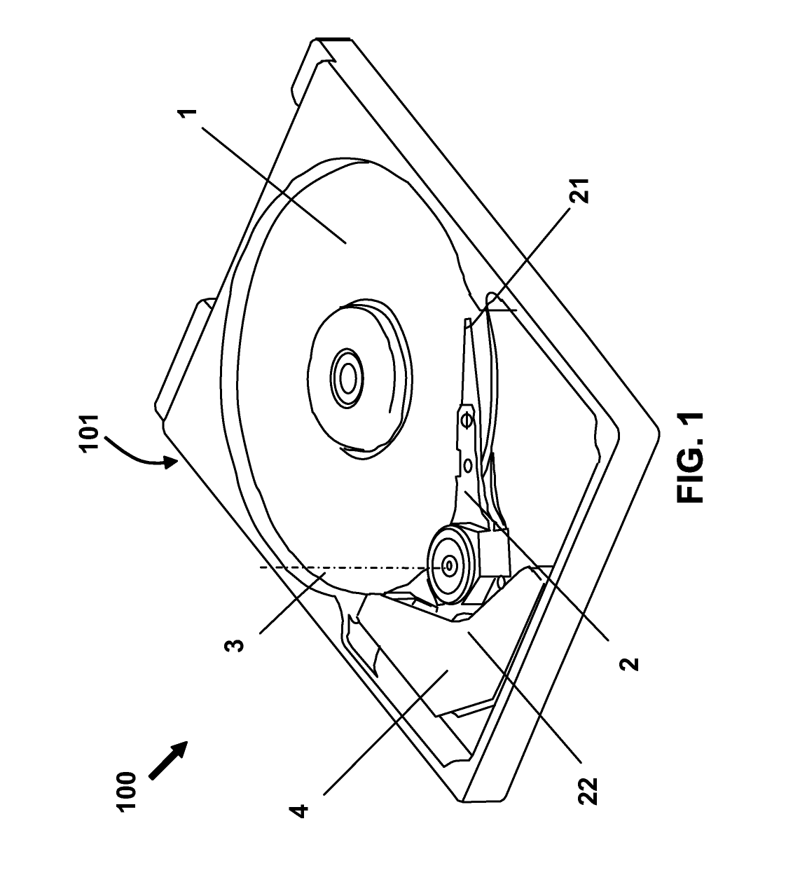

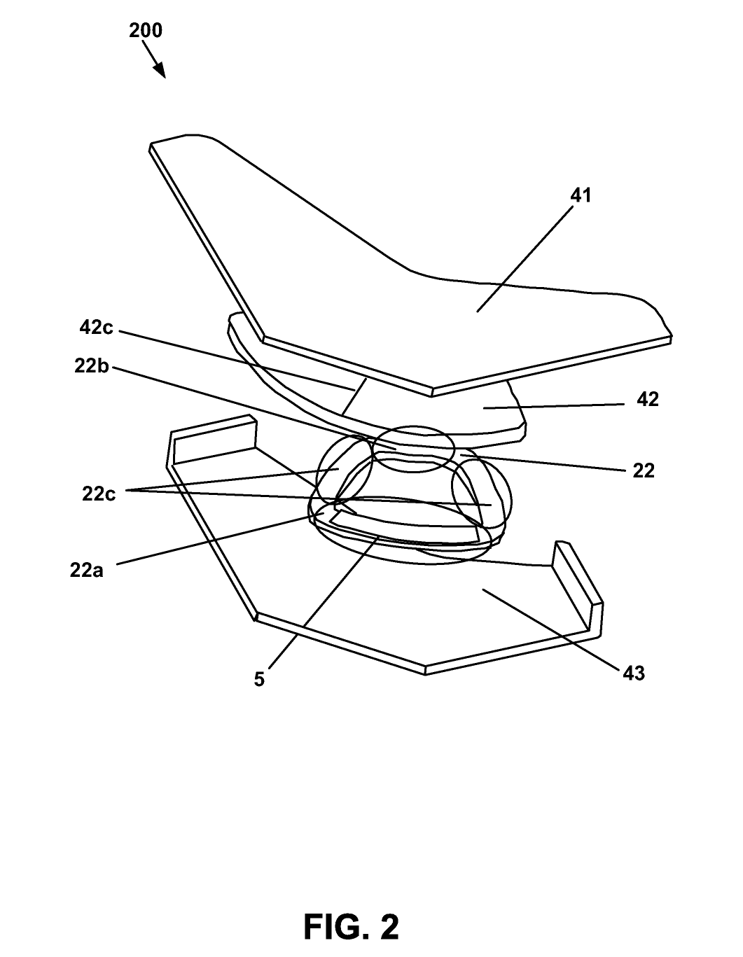

With reference now to FIGS. 1 and 2, in accordance with embodiments of the present invention, an oblique view 100 showing an example embodiment of a HDD 101 is shown in FIG. 1; and, in FIG. 2, an exploded oblique view 200 is shown of a VCM 4 including a voice coil 22, VCM magnet 42, and flux guide 5. In the subsequent description of HDD 101, rotary actuator 2 and VCM 4, embodiments of the present invention incorporate within the environments of HDD 101, rotary actuator 2 and VCM 4, without limitation thereto, the subsequently described embodiments of the present invention for the voice coil 22, and flux guides, for example, flux guide 5, which are suitable for incorporation within the environments of HDD 101, rotary actuator 2 and VCM 4. Moreover, HDD 101 is but one representative environment for embodiments of the present invention, as embodiments of the present invention also encompass within their spirit and scope other types of disk drives, for example, such as: optical drives that include one or more optical disks, magneto-optical drives that include one or more magneto-optical disks, floppy-disk drives that include one or more flexible magnetic-recording disks, and similar disk data-storage devices. Furthermore, although rotary actuator 2 and VCM 4 are shown in the environment of HDD 101, this is by way of example without limitation thereto, as other embodiments of the present invention encompass within their spirit and scope rotary actuators and VCMs that may be used in other types of disk drives, for example, those listed above.

With further reference to FIGS. 1 and 2, in accordance with embodiments of the present invention, a flux guide 5 made of a soft magnetic material is disposed at an outer peripheral portion 22a of the voice coil 22, which is a portion of the voice coil 22 that is substantially parallel to the direction of rotation of the rotary actuator 2 about a pivot shaft 3 and is distal from the pivot shaft 3; alternatively, a flux guide made of a soft magnetic material may also be disposed at an inner peripheral portion 22b of the voice coil 22, which is a portion of the voice coil 22 that is substantially parallel to the direction of rotation of the rotary actuator 2 about the pivot shaft 3 and is close to the pivot shaft 3. In accordance with embodiments of the present invention, the out-of-plane excitation force which acts on the voice coil 22 is reduced, and vibration of the magnetic-recording head can be suppressed. Thus, in accordance with embodiments of the present invention, the positioning accuracy of the magnetic-recording head on a specific recording track can be increased, which allows for an HDD having an increased data-storage capacity. Example embodiments of the present invention are further described below with the aid of the figures.

### First Example Embodiment

With further reference to FIG. 1, in accordance with embodiments of the present invention, HDD 101 includes at least one head-gimbal assembly (HGA) including a magnetic-recording head 21, a lead-suspension attached to the magnetic-recording head 21, and a load beam attached to a slider, which includes the magnetic-recording head 21 at a distal end of the slider; the slider is attached at the distal end of the load beam to a gimbal portion of the load beam. HDD 101 also includes at least one magnetic-recording disk 1 rotatably mounted on a spindle and a drive motor (not shown) mounted in a disk-enclosure (DE) base and attached to the spindle for rotating the magnetic-recording disk 1. The magnetic-recording head 21 that includes a write element, a so-called writer, and a read element, a so-called reader, is disposed for respectively writing and reading information, referred to by the term of art, “data,” stored on the magnetic-recording disk 1 of HDD 101. The magnetic-recording disk 1, or a plurality (not shown) of magnetic-recording disks, may be affixed to the spindle by a disk clamp. HDD 101 further includes: a rotary actuator 2 that is attached to the HGA and includes a carriage; the VCM 4 that includes the voice coil 22, which is integrated with the actuator 2 through attachment to the carriage, and the VCM magnet 42 (see FIG. 2); the VCM 4 is configured to move the rotary actuator 2 and HGA to access portions of the magnetic-recording disk 1, as the carriage of the rotary actuator 2 is mounted on the pivot-shaft 3 with an interposed pivot-bearing assembly. HDD 101 may also include a load-unload ramp for the HGA that is configured to engage a tongue of HGA at the far distal end of HGA when rotary actuator 2 is retracted from a position for flying the magnetic-recording head 21 in proximity with the magnetic-recording disk 1.

With further reference to FIG. 1, in accordance with embodiments of the present invention, electrical signals, for example, current to the voice coil 22 of VCM 4, write signals to and read signals from the magnetic-recording head 21, are provided by a flexible cable. Interconnection between the flexible cable and the magnetic-recording head 21 may be provided by an arm-electronics (AE) module, which may have an on-board pre-amplifier for the read signal, as well as other read-channel and write-channel electronic components. The flexible cable is coupled to an electrical-connector block, which provides electrical communication through electrical feedthroughs provided by the DE base. The DE base, also referred to as a casting, depending upon whether the DE base is cast, in conjunction with a DE cover (not shown in FIG. 1) provides a sealed, protective DE for the information storage components of HDD 101.

With further reference to FIG. 1, in accordance with embodiments of the present invention, other electronic components (not shown), including a disk controller and servo electronics including a digital-signal processor (DSP), provide electrical signals to the drive motor, the voice coil 22 of VCM 4 and the magnetic-recording head 21. The electrical signal provided to the drive motor enables the drive motor to spin providing a torque to the spindle which is in turn transmitted to the magnetic-recording disk 1 that is affixed to the spindle by the disk clamp; as a result, the magnetic-recording disk 1 spins. The spinning magnetic-recording disk 1 creates an airflow including an air-stream, and a cushion of air that acts as an air bearing on which the air-bearing surface (ABS) of the slider rides so that the slider flies in proximity with the surface of the magnetic-recording disk 1 with minimal contact between the slider and the magnetic-recording disk 1 in which information is recorded. The electrical signal provided to the voice coil 22 of VCM 4 enables the magnetic-recording head 21 to access a track on which information is recorded. Thus, the rotary actuator 2 swings through an arc which enables magnetic-recording head 21 to access various tracks on the magnetic-recording disk 1. Information is stored on the magnetic-recording disk 1 in a plurality of concentric tracks (not shown) arranged in sectors on the magnetic-recording disk 1. Correspondingly, each track is composed of a plurality of sectored track portions. Each sectored track portion is composed of recorded data and a header containing a servo-burst-signal pattern, for example, an ABCD-servo-burst-signal pattern, information that identifies a track, and error correction code information. In accessing the track, the read element of the magnetic-recording head 21 of HGA reads the servo-burst-signal pattern which provides a position-error-signal (PES) to the servo electronics, which controls the electrical signal provided to the voice coil 22 of VCM 4, enabling the magnetic-recording head 21 to follow the track. Upon finding the track and identifying a particular sectored track portion, the magnetic-recording head 21 either reads data from the track, or writes data to, the track depending on instructions received by the disk controller from an external agent, for example, a microprocessor of a computer system.

With further reference to FIGS. 1 and 2, embodiments of the present invention encompass within their scope, a disk drive, for example, HDD 101, that includes: at least one head, for example, magnetic-recording head 21; at least one disk, for example, magnetic-recording disk 1, rotatably mounted in the disk drive; a rotary actuator 2 coupled with the head at a distal end of the rotary actuator 2; and, the VCM 4. In accordance with embodiments of the present invention, the VCM 4 includes at least one VCM magnet 42 (see FIG. 2), the voice coil 22 and at least one flux guide, for example, flux guide 5 (see FIG. 2), coupled to the voice coil 22. In accordance with embodiments of the present invention, the voice coil 22 is disposed in proximity to a magnetic pole of the VCM magnet 42, and is disposed at an end of the actuator 2 opposite to the distal end, where the head is disposed. In accordance with embodiments of the present invention, the rotary actuator 2 may include the voice coil 22, and at least one flux guide, for example, flux guide 5 (see FIG. 2), coupled to the voice coil 22. In accordance with embodiments of the present invention, the rotary actuator 2 is configured to move the head to access portions of the disk for writing data to, and reading data from, the disk. In accordance with embodiments of the present invention, the flux guide, for example, flux guide 5 (see FIG. 2), is configured to reduce vibrations of the head when accessing data stored on the disk in the disk drive. As described above, embodiments of the present invention include within their spirit and scope: a disk drive, for example, HDD 101; a head, for example, magnetic-recording head 21; and, a disk, for example, magnetic-recording disk 1.

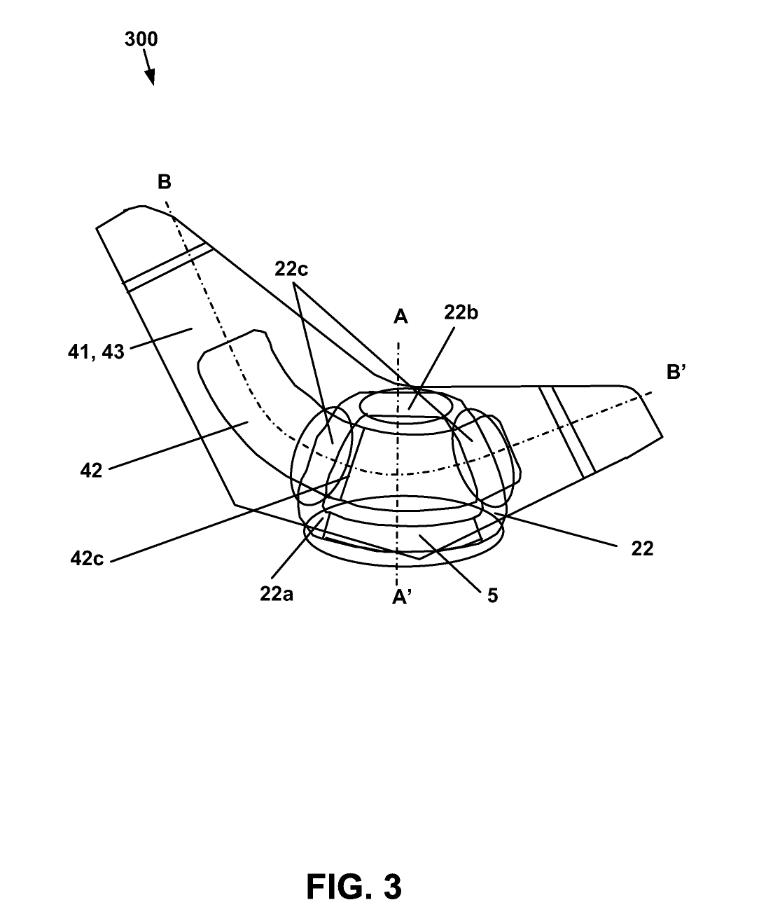

With reference now to FIG. 3 and further reference to FIG. 2, in accordance with the first example embodiment of the present invention, a top transparent view 300 is shown of the VCM 4 including the voice coil 22, VCM magnet 42 and flux guide 5. The VCM 4 includes a VCM magnet 42 for producing magnetic flux, and an upper yoke 41 and lower yoke 43, which together form a magnetic circuit and efficiently apply the magnetic flux generated by the VCM magnet 42 to the voice coil 22, which faces the yokes. Magnets, similar to VCM magnet 42, may also be affixed to both sides of the upper yoke 41 and lower yoke 43, but in the example described herein, the VCM magnet 42 is affixed only to the upper yoke 41 side in order to reduce cost. Furthermore, the VCM magnet 42 is magnetized with reverse polarities on either side of a polarization line 42c, which serves as a boundary between portions of the VCM magnet 42 with opposite polarization.

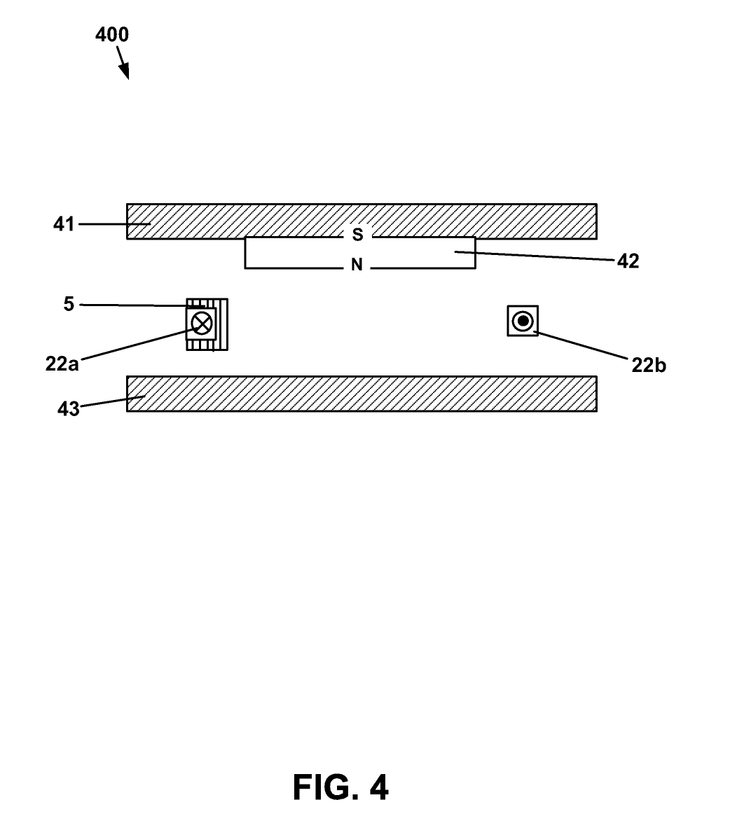

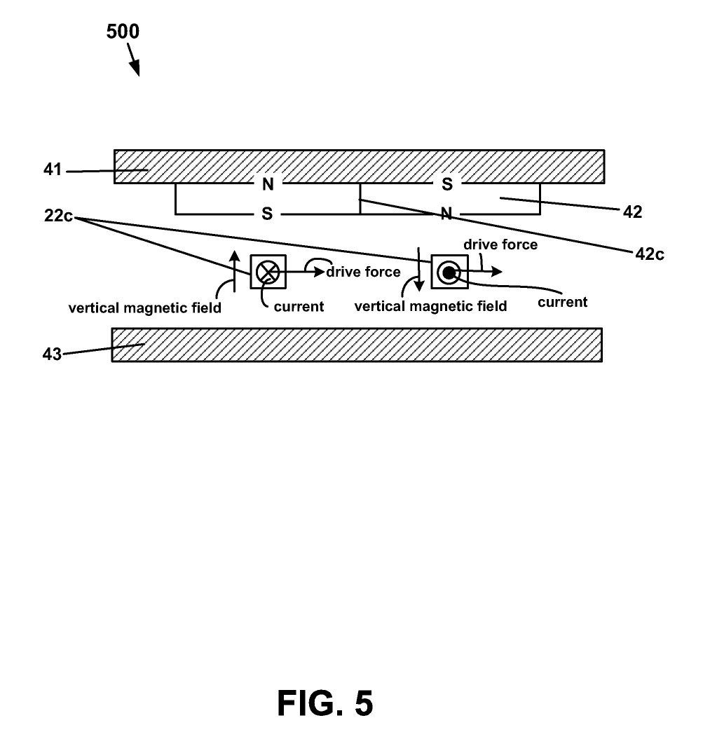

With further reference to FIGS. 1-3, in accordance with the first example embodiment of the present invention, the flux guide 5 made of a soft magnetic material is formed at the portion of the voice coil 22, which is furthest from the pivot shaft 3; and, the flux guide 5 is designed to absorb magnetic flux from the VCM magnet 42. The portion of the voice coil 22 that is parallel to the direction of rotation of the rotary actuator 2 about the pivot shaft 3 and distal from the pivot shaft is referred to as the outer peripheral portion 22a of the voice coil 22. Furthermore, the portion of the voice coil 22 which is parallel to the direction of rotation of the rotary actuator 2 about the pivot shaft 3 and is close to the pivot shaft is referred to as the inner peripheral portion 22b of the voice coil 22. Furthermore, the two straight-line portions of the voice coil 22 that are substantially perpendicular to the direction of rotation of the rotary actuator 2 about the pivot shaft 3 are referred to below as the straight-line portions 22c of the voice coil 22. In accordance with the first example embodiment of the present invention, iron, nickel or similar material of high magnetic permeability may be used as the soft magnetic material of the flux guides. In accordance with the first example embodiment of the present invention, VCM 4 includes the upper yoke 41 and lower yoke 43, which is subsequently described in FIGS. 4 and 5, with the aid of a section along contour B-B′. Moreover, in accordance with the first example embodiment of the present invention, VCM 4 includes the flux guide 5, which is next described, with the aid of a section along line A-A′.

With reference now to FIG. 4, in accordance with the first example embodiment of the present invention, a cross-sectional elevation view 400 is shown of the VCM 4 including the outer peripheral portion 22a and the inner peripheral portion 22b of the voice coil 22, VCM magnet 42, and flux guide 5. FIG. 4 shows a cross section along A-A′ of FIG. 3, wherein the VCM magnet 42 faces the outer peripheral portion 22a of the voice coil 22 and the inner peripheral portion 22b of the voice coil 22. The flux guide 5 is disposed at the outer peripheral portion 22a of the voice coil 22. The flux guide is designed to cover the inner side and upper and lower surfaces of the outer peripheral portion 22a of the voice coil 22. The disposition of the VCM magnet 42 with respect to the upper yoke 41 and lower yoke 43 is also shown in FIG. 4. The symbols “N” and “S” shown in FIG. 4, and as used elsewhere in figures herein, denote north and south poles, respectively, of the VCM magnet 42. Moreover, the symbols “X” and “dot” shown in FIG. 4, and as used elsewhere in figures herein, denote tail and head, respectively, of the electrical current vector for electrical current flowing in portions of the voice coil 22.

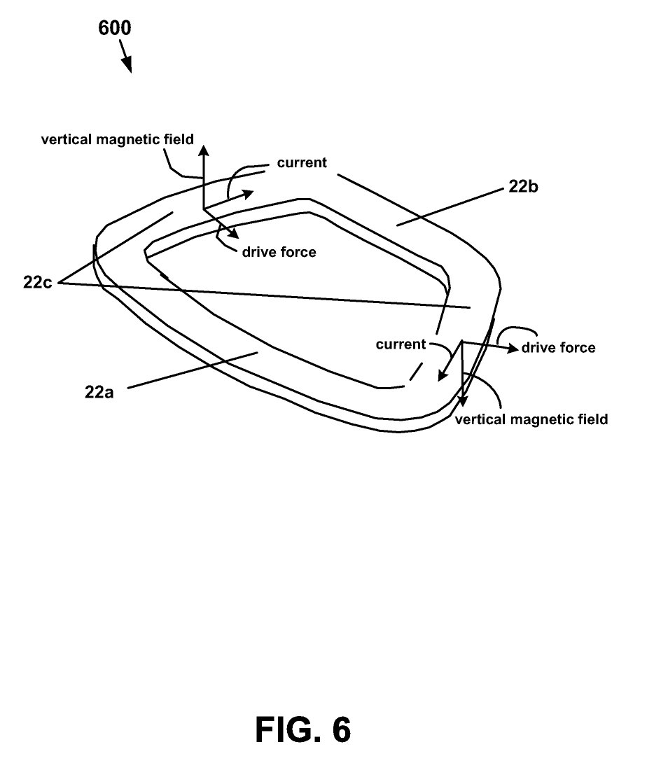

With reference now to FIGS. 5 and 6, in accordance with the first example embodiment of the present invention, a cross-sectional elevation view 500 is shown in FIG. 5 of the VCM 4 including the straight-line portions 22c of the voice coil 22, and the VCM magnet 42 through the cross section along contour B-B′ of FIG. 3; and, in FIG. 6, a perspective view 600 of the voice coil 22 that illustrates the principle of operation of the VCM 4 by which the voice coil 22 is moved by a drive force generated by interaction of a current flowing through the voice coil 22 with a magnetic field emanating from the VCM magnet 42. FIG. 5 shows a cross section along contour B-B′ in FIG. 3, wherein the VCM magnet 42 faces the straight-line portions 22c of the voice coil 22 that cut across the VCM magnet 42. In FIG. 5, wherein current is flowing to the voice coil 22, the cross section of the straight-line portions 22c of the voice coil 22 facing the VCM magnet 42 receive vertical magnetic fields in mutually opposite directions from the VCM magnet 42, and a drive force is produced. FIG. 6 shows altogether the current flowing to the voice coil 22, the magnetic field that is acting on the voice coil 22, particularly the straight-line portions 22c of the voice coil 22, and the drive force that is produced to move the actuator 2 in accessing the disk, for example, magnetic-recording disk 1 of HDD 101. However, the magnetic flux produced at the end of the VCM magnet 42 does not reach the upper yoke 41 in a perpendicular fashion, which is next described.

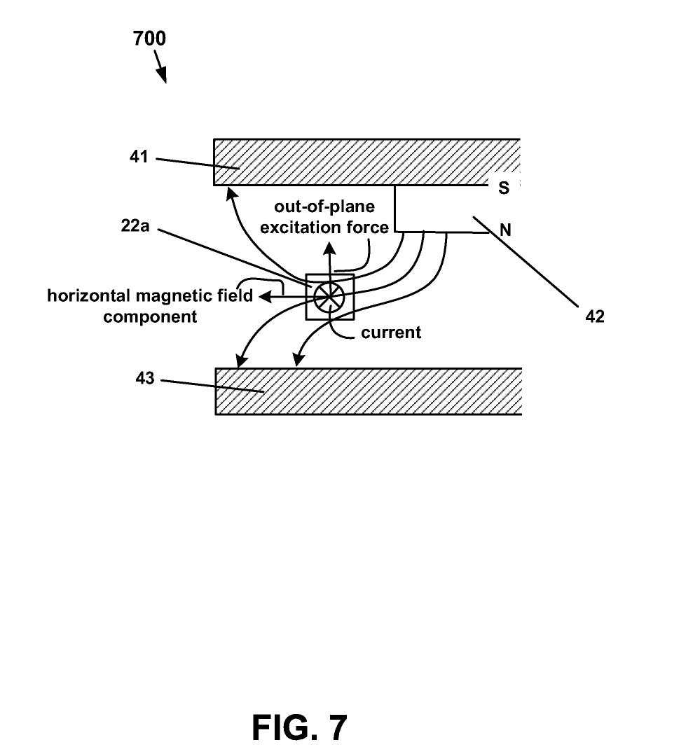

With reference now to FIG. 7, with relevance for embodiments of the present invention, a cross-sectional elevation view 700 is shown of the VCM 4 including the voice coil 22, and VCM magnet 42; FIG. 7 illustrates the results of a magnetic field analysis for the outer peripheral portion 22a of the voice coil 22 in the case where the voice coil 22 does not utilize a flux guide, similar to the flux guide 5 of the first example embodiment of the present invention. As shown in FIG. 7, some of the magnetic flux is oriented toward the upper yoke 41, while the rest of the magnetic flux reaches the lower yoke 43, as indicated by the bending magnetic flux lines, bending under the influence of the high magnetic permeability material of yokes 41 and 43. Consequently, the horizontal magnetic field component shown by the arrow, directed towards the left, is applied to the outer peripheral portion 22a of the voice coil 22; and, a force, which is an out-of-plane excitation force that is directed upwards “out of” the plane of the voice coil 22, is generated in the perpendicular direction.

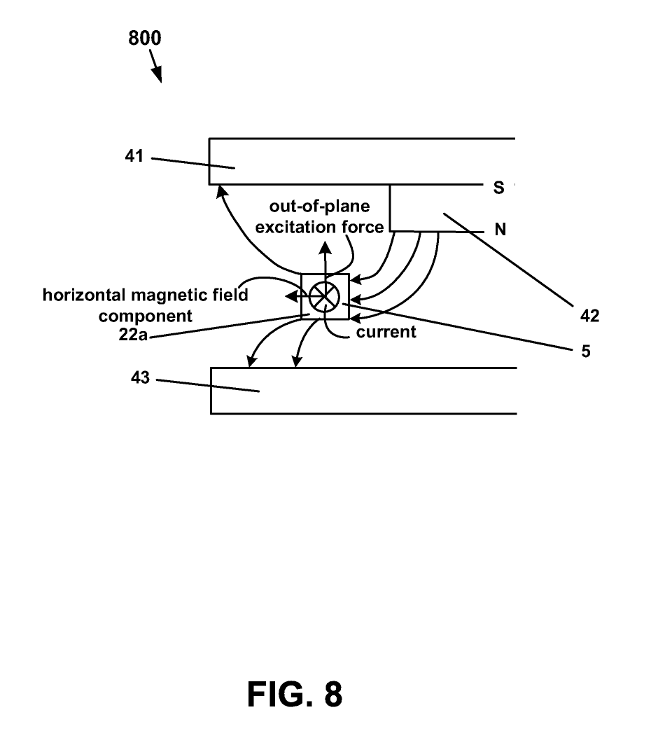

With reference now to FIG. 8, in accordance with the first example embodiment of the present invention, a cross-sectional elevation view 800 is shown of the VCM 4 including the voice coil 22, VCM magnet 42, and the flux guide 5; FIG. 8 illustrates the results of a magnetic field analysis for the outer peripheral portion 22a of the voice coil 22 in the case where the voice coil 22 does utilize the flux guide 5. FIG. 8 shows the principle of the first example embodiment. In the first example embodiment, the magnetic flux produced at the end of the VCM magnet 42 is absorbed by the flux guide 5 which is disposed at the inner side and upper and lower surfaces of the outer peripheral portion 22a of the voice coil 22, with some of the magnetic flux being oriented toward the upper yoke 41, while the rest reaches the lower yoke 43. Consequently, the horizontal magnetic field component which is applied to the outer peripheral portion 22a of the voice coil 22 is reduced, and the out-of-plane excitation force is also reduced.

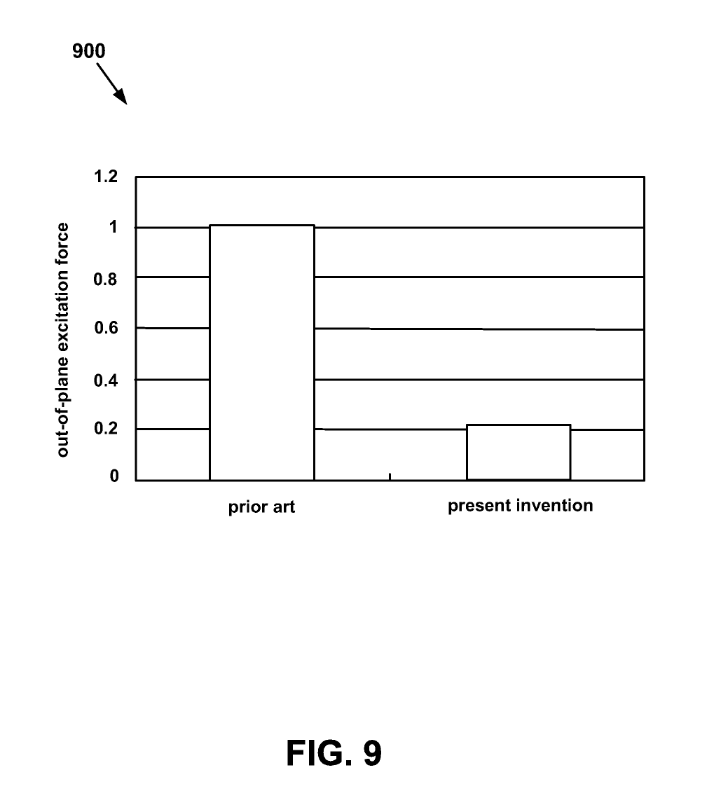

With reference now to FIG. 9, a bar chart 900 is shown that is based on the results of magnetic field analysis yielding the out-of-plane excitation force on the outer peripheral portion 22a of the voice coil 22; FIG. 9 compares the case where the voice coil 22 does not utilize a flux guide (prior art) with the case where the voice coil 22 utilizes the flux guide 5 in accordance with the first example embodiment of the present invention. The vertical axis of the bar chart 900 represents the out-of-plane excitation force, wherein the scale is normalized so that 1 is taken to be the value in the case of the configuration of FIG. 7 without the flux guide. For the first example embodiment in FIG. 8, the out-of-plane excitation force of the outer peripheral portion 22a of the voice coil 22 is 0.22; a value approximately 78% lower than in the case of a configuration without the flux guide. In accordance with the first example embodiment of the present invention, the flux guide 5 is disposed only on the outer peripheral portion 22a of the voice coil 22, and the flux guide is not disposed on the straight-line portions 22c of the voice coil 22 which generate the drive force. Consequently, the horizontal magnetic field component applied to the outer peripheral portion 22a of the voice coil 22 is reduced without a reduction in the drive force applied to the rotary actuator 2 about the pivot shaft 3. As a result, the out-of-plane excitation force of the VCM 4 that acts on the voice coil 22 is significantly reduced without a reduction in the drive force of the rotary actuator 2, and vibration of the magnetic-recording head 21 in HDD 101 is suppressed. Thus, in accordance with embodiments of the present invention, the flux guide of VCM 4 is configured to reduce an out-of-plane excitation force acting on the voice coil 22 that is a force that acts on the voice coil 22 in a direction perpendicular to the plane of movement of the voice coil 22 for accessing data in the disk drive. Moreover, in accordance with the first example embodiment of the present invention, the flux guide 5 of VCM 4 is mounted on the outer peripheral portion 22a of the voice coil 22; and, the flux guide 5 of VCM 4 may wrap around three sides of the outer peripheral portion 22a of the voice coil 22, as shown in detail in FIGS. 4 and 8.

### Second Example Embodiment

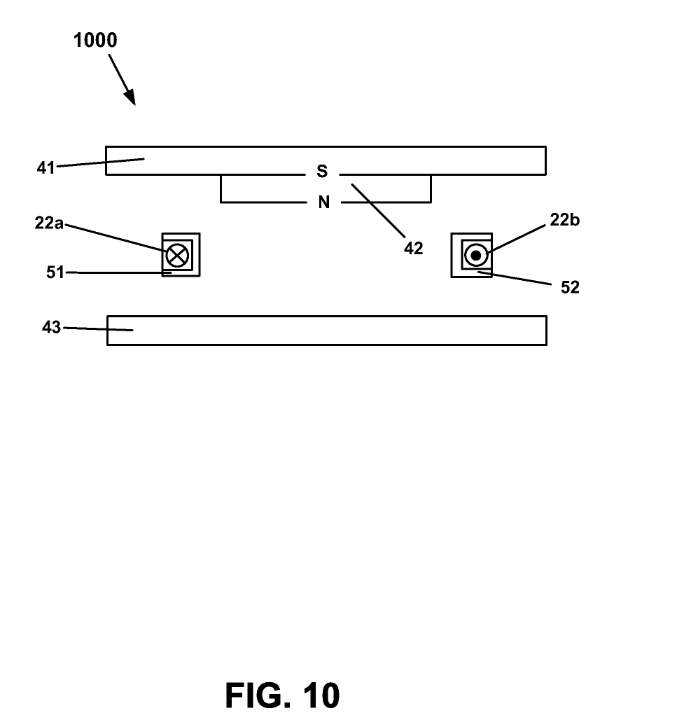

With reference now to FIG. 10, in accordance with the second example embodiment of the present invention, a cross-sectional elevation view 1000 is shown of the VCM 4 including the voice coil 22, VCM magnet 42, and flux guides 51 and 52. In the second example embodiment, a flux guide 51, similar to flux guide 5 of the first example embodiment, is disposed on the outer peripheral portion 22a of the voice coil 22, and a second flux guide 52 is disposed on the inner peripheral portion 22b of the voice coil 22. The horizontal magnetic field component from the end of the VCM magnet 42 also acts on the inner peripheral portion 22b of the voice coil 22; and, therefore, an out-of-plane excitation force is generated at the inner peripheral portion 22b of the voice coil 22. Although the out-of-plane excitation force generated at the inner peripheral portion 22b of the voice coil 22 is less effective than an out-of-plane excitation force generated at the outer peripheral portion 22a of the voice coil 22, because the inner peripheral portion 22b of the voice coil 22 is shorter than the outer peripheral portion 22a of the voice coil 22, and because the inner peripheral portion 22b of the voice coil 22 is closer to the pivot shaft than the outer peripheral portion 22a of the voice coil 22, vibration of the magnetic-recording head 21 may, nevertheless, be further suppressed by providing the second flux guide 52. Thus, in accordance with the second example embodiment of the present invention, the VCM 4 further includes a second flux guide 52 coupled to the voice coil 22; and, the second flux guide 52 is configured to reduce vibrations of the head, for example, magnetic-recording head 21, when accessing data in a disk drive, for example, HDD 101. Moreover, in accordance with the second example embodiment of the present invention, the second flux guide 52 of VCM 4 is mounted on an inner peripheral portion 22b of the voice coil 22; and, the second flux guide 52 of VCM 4 may wrap around three sides of the inner peripheral portion 22b of the voice coil 22, as shown in detail in FIG. 10.

### Third Example Embodiment

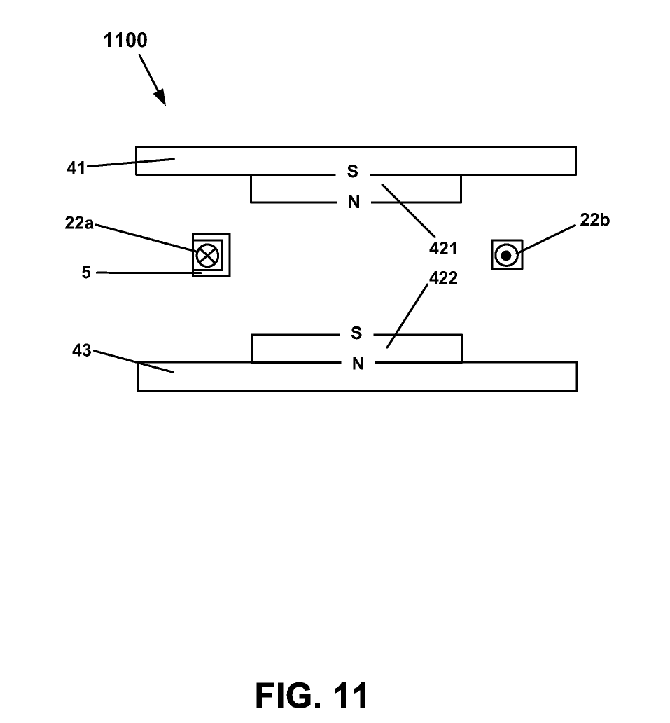

With reference now to FIG. 11, in accordance with the third example embodiment of the present invention, a cross-sectional elevation view 1100 is shown of the VCM 4 including the voice coil 22, two VCM magnets 421 and 422, and flux guide 5. In accordance with the third example embodiment of the present invention, the VCM 4 further includes a second VCM magnet 422 that is disposed on the lower yoke 43. In the third example embodiment, respective VCM magnets 421 and 422 are disposed on the two vertical yokes, upper yoke 41 and lower yoke 43, and the flux guide 5 is disposed around the outer peripheral portion 22a of the voice coil 22. Even with a structure in which both the upper and lower yokes 41 and 43 are provided with VCM magnets 421 and 422, respectively, the out-of-plane excitation force may still be produced by differences in the shapes of the upper and lower yokes 41 and 43 and the VCM magnets 421 and 422; alternatively, the out-of-plane excitation force may also be produced by positional offsets between the voice coil 22 and VCM magnets 421 and 422, or by positional offsets between the upper and lower VCM magnets 421 and 422, themselves. Thus, in accordance with the third example embodiment of the present invention, the out-of-plane excitation force may be suppressed by providing the flux guide 5 of the third example embodiment in the presence of both VCM magnet 421, similar to VCM magnet 42, previously described, disposed on the upper yoke 41, and a second VCM magnet 422 disposed on the lower yoke 43.

### Fourth Example Embodiment

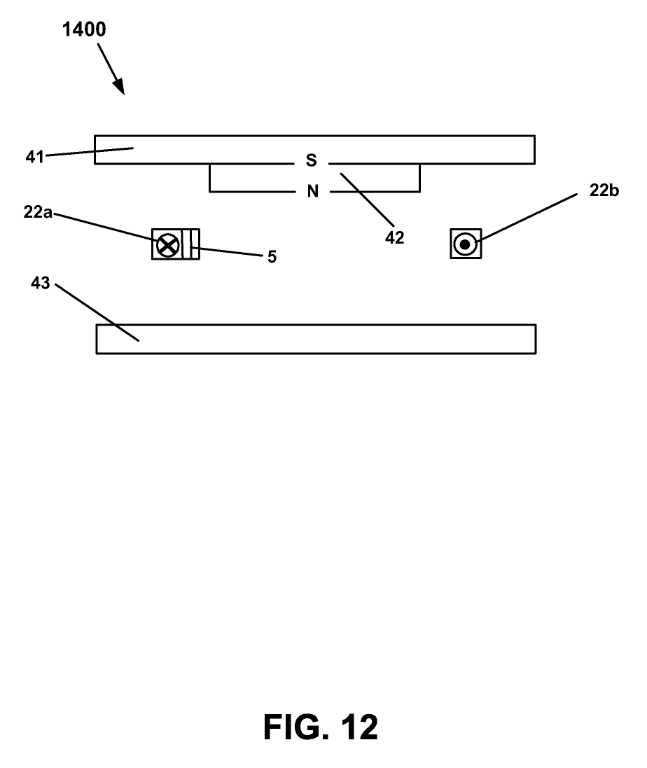

With reference now to FIG. 12, in accordance with the fourth example embodiment of the present invention, a cross-sectional elevation view 1200 is shown of the VCM 4 including the voice coil 22, VCM magnet 42, and flux guide 5. In accordance with the fourth example embodiment of the present invention, the flux guide 5 is disposed only on the inner side of the outer peripheral portion 22a of the voice coil 22. An effect whereby the horizontal magnetic field component acting on the voice coil is reduced can still be achieved if the flux guide 5 is disposed on either the upper or lower surface of the voice coil outer peripheral portion, or on neither. Furthermore, the flux guide 5 of the fourth example embodiment is simpler to produce than the flux guide 5 of the first example embodiment.

### Fifth Example Embodiment

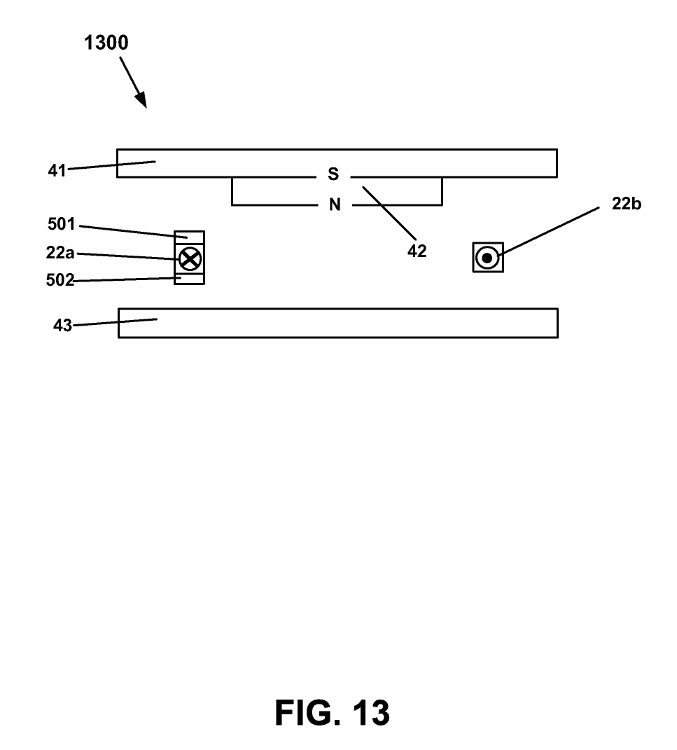

With reference now to FIG. 13, in accordance with the fifth example embodiment of the present invention, a cross-sectional elevation view 1300 is shown of the VCM 4 including the voice coil 22, VCM magnet 42, and flux guide 5. In accordance with the fifth example embodiment of the present invention, the flux guide 5 includes a first portion 501 disposed on an upper side of the outer peripheral portion 22a of the voice coil 22, and a second portion 502 disposed on a lower side of the outer peripheral portion 22a of the voice coil 22. In accordance with the fifth example embodiment of the present invention, flux-guide portions 501 and 502 are disposed in order to cover the voice coil upper and lower surfaces, respectively, of the outer peripheral portion 22a of the voice coil 22. An effect whereby the horizontal magnetic field component acting on the voice coil 22 is reduced can still be achieved if the flux guide 5 is not a single piece. Furthermore, the flux-guide portions 501 and 502 of the fifth example embodiment are simpler to produce than the flux guide 5 of the first example embodiment.

### Sixth Example Embodiment

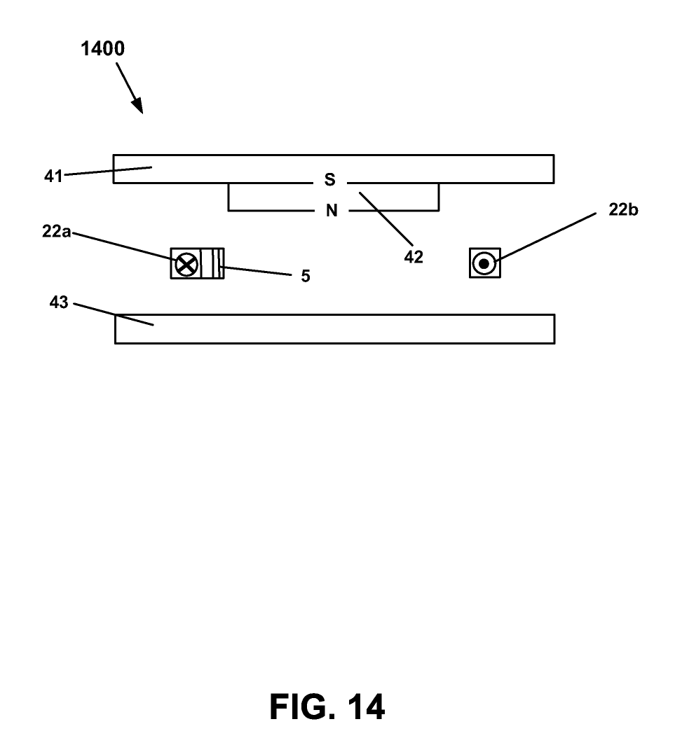

With reference now to FIG. 14, in accordance with the sixth example embodiment of the present invention, a cross-sectional elevation view 1400 is shown of the VCM 4 including the voice coil 22, VCM magnet 42, and flux guide 5. In accordance with the sixth example embodiment of the present invention, the flux guide 5 is disposed in proximity to an inner side of the outer peripheral portion 22a of the voice coil 22, and is offset at a distance from the inner side of the outer peripheral portion 22a of the voice coil 22. An effect whereby the horizontal magnetic field component acting on the voice coil 22 is reduced can still be achieved if the flux guide 5 is not in contact with the voice coil 22. Furthermore, the flux guide 5 of the sixth example embodiment is simpler to produce than the flux guides of the first example embodiment and the fourth example embodiment, respectively.

The foregoing descriptions of specific embodiments of the present invention have been presented for purposes of illustration and description. They are not intended to be exhaustive or to limit the invention to the precise forms disclosed, and many modifications and variations are possible in light of the above teaching. In particular, the various embodiments of the present invention described above are also effective for structures in which the above-described example embodiments may be combined together. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A voice-coil motor with flux guide configured to reduce vibrations of a head when accessing data in a disk drive, said voice-coil motor comprising:
at least one voice-coil-motor magnet;
a voice coil disposed in proximity to a magnetic pole of said voice-coil-motor magnet; and
at least one flux guide coupled to said voice coil;
wherein said flux guide is configured to reduce vibrations of said head when accessing data in said disk drive.

2. The voice-coil motor of claim 1, wherein said flux guide is configured to reduce a force that acts on said voice coil in a direction perpendicular to the plane of movement of said voice coil for accessing data in said disk drive.

3. The voice-coil motor of claim 1, wherein said flux guide is mounted on an outer peripheral portion of said voice coil.

4. The voice-coil motor of claim 3, wherein said flux guide wraps around three sides of said outer peripheral portion of said voice coil.

5. The voice-coil motor of claim 3, wherein said flux guide is disposed on an inner side of said outer peripheral portion of said voice coil.

6. The voice-coil motor of claim 3, wherein said flux guide is disposed in proximity to an inner side of said outer peripheral portion of said voice coil, and is offset at a distance from said inner side of said outer peripheral portion of said voice coil.

7. The voice-coil motor of claim 3, wherein said flux guide comprises:
a first portion disposed on an upper side of said outer peripheral portion of said voice coil; and
a second portion disposed on a lower side of said outer peripheral portion of said voice coil.

8. The voice-coil motor of claim 1, further comprising:
a second flux guide coupled to said voice coil;
wherein said second flux guide is configured to reduce vibrations of said head when accessing data in a disk drive.

9. The voice-coil motor of claim 8, wherein said wherein said second flux guide is mounted on an inner peripheral portion of said voice coil.

10. The voice-coil motor of claim 8, wherein said second flux guide wraps around three sides of said inner peripheral portion of said voice coil.

11. The voice-coil motor of claim 1, further comprising a second voice-coil-motor magnet.

12. A rotary actuator for a disk drive, comprising:
a voice coil; and
at least one flux guide coupled to said voice coil;
wherein said flux guide is configured to reduce vibrations of a head when accessing data in said disk drive.

13. The rotary actuator of claim 12, wherein said flux guide is mounted on an outer peripheral portion of said voice coil.

14. The rotary actuator of claim 12, wherein said flux guide wraps around three sides of said outer peripheral portion of said voice coil.

15. The rotary actuator of claim 12, further comprising:
a second flux guide coupled to said voice coil;
wherein said second flux guide is configured to reduce vibrations of said head when accessing data in a disk drive.

16. The rotary actuator of claim 15, wherein said wherein said second flux guide is mounted on an inner peripheral portion of said voice coil.

17. A disk drive, comprising:
at least one head;
at least one disk rotatably mounted in said disk drive;
a rotary actuator coupled with said head at a distal end of said rotary actuator;
wherein said rotary actuator is configured to move said head to access portions of said disk for writing data to, and reading data from, said disk; and
a voice-coil motor, comprising:
at least one voice-coil-motor magnet;
a voice coil disposed in proximity to a magnetic pole of said voice-coil-motor magnet, disposed at an end of said actuator opposite to said distal end; and
at least one flux guide coupled to said voice coil;
wherein said flux guide is configured to reduce vibrations of said head when accessing data stored on said disk in said disk drive.

18. The disk drive of claim 17, wherein said flux guide is mounted on an outer peripheral portion of said voice coil.

19. The disk drive of claim 17, wherein said voice-coil motor further comprises:
a second flux guide coupled to said voice coil;
wherein said second flux guide is configured to reduce vibrations of said head when accessing data in a disk drive.

20. The disk drive of claim 19, wherein said second flux guide is mounted on an inner peripheral portion of said voice coil.

21. The disk drive of claim 17, wherein said voice-coil-motor magnet is disposed on an upper yoke; and
wherein said voice-coil motor further comprises:
a second voice-coil-motor magnet disposed on a lower yoke.

22. The disk drive of claim 17, wherein and said head comprises a magnetic-recording head; said disk comprises a magnetic-recording disk; and said disk drive comprises a hard-disk drive.
